(19) United States
(12) Patent Application Publication
(10) Pub. No.: US 2026/0140380 A1
(43) Pub. Date: May 21, 2026

(54) DISPLAY APPARATUS

(71) Applicant: TRIPLE WIN TECHNOLOGY (SHENZHEN) CO. LTD., Shenzhen (CN)

(72) Inventors: CHENG-HSING LIAO, New Taipei (TW); YEW-KOON CHEE, New Taipei (TW); MING-CHUAN KUO, New Taipei (TW)

(21) Appl. No.: 19/187,016

(22) Filed: Apr. 23, 2025

(30) Foreign Application Priority Data
Nov. 15, 2024 (CN) 202411637508.2

(51) Int. Cl. G02B 27/01; G02B 27/10; G02B 27/14

(52) U.S. Cl. CPC G02B 27/0172; G02B 27/102; G02B 27/149

(57) ABSTRACT

A display apparatus includes a first micro-display, a second micro-display for emitting a first light beam, a light combining element for emitting a second light beam, a projection lens including a light exit surface, and an optical waveguide. The projection lens includes a lens assembly and a meta optical structure. The lens assembly is used to receive the first light beam and the second light beam from the light exit surface and modulate the first light beam and the second light beam. The meta optical structure is used to control directions of the first light beam and the second light beam to make the first light beam and the second light beam exit from the projection lens at different angles. The projection lens project the first light beam and the second light beam to the optical waveguide in the respective directions which are not parallel to each other.

### FIELD

The subject matter herein generally relates to a display apparatus.

### BACKGROUND

A wearable display apparatus may include a display, an X-cube, an optical waveguide, etc. Color wearable display apparatus receives light beams of different wavelengths (representing different colors) and combines the light beams to generate image light. The image light undergoes multiple total reflections in the optical waveguide and are coupled to human eye to display images.

However, due to different wavelengths of the light beams in the image light, the following issues exist:

(1) light beams having different diffraction angles in the optical waveguide have different optical path lengths during each total reflection. As such, the light beams in the image light are coupled out of the optical waveguide for different times and at different positions, which can lead to uneven color ratios at different observation positions in an eye box, resulting in a “rainbow effect”; and

(2) for light beams of a same color, a diffraction efficiency of the light beams vary with different incident angles, which leads to different distribution ratios within an entire field of view (FOV) and also results in the “rainbow effect”.

### BRIEF DESCRIPTION OF THE DRAWINGS

Implementations of the present disclosure will now be described, by way of embodiment, with reference to the attached figures, wherein:

FIG. 1 shows a display apparatus according to a first embodiment of the present disclosure.

FIG. 2 shows a display apparatus according to a second embodiment of the present disclosure.

FIG. 3 is a planar view of an embodiment of an optical waveguide of the display apparatus shown in in FIG. 2.

FIG. 4 is a planar view of another embodiment of an optical waveguide of the display apparatus shown in FIG. 2.

FIG. 5 is a planar view of another embodiment of an optical waveguide of the display apparatus shown in FIG. 2.

FIG. 6 is a planar view of another embodiment of an optical waveguide of the display apparatus shown in FIG. 2.

FIG. 7 shows optical paths of light beams in the display apparatus shown in FIG. 2.

FIG. 8 shows a display apparatus according another embodiment of the present disclosure.

FIG. 9 shows a display apparatus according to another embodiment of the present disclosure.

FIG. 10 shows a display apparatus according to yet another embodiment of the present disclosure.

FIG. 11 shows a display apparatus according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is on top of another layer. In one example, it means one layer is situated directly on top of another layer. In another example, it means one layer is situated over the second layer directly or indirectly with more layers or spacers in between.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

### Embodiment 1

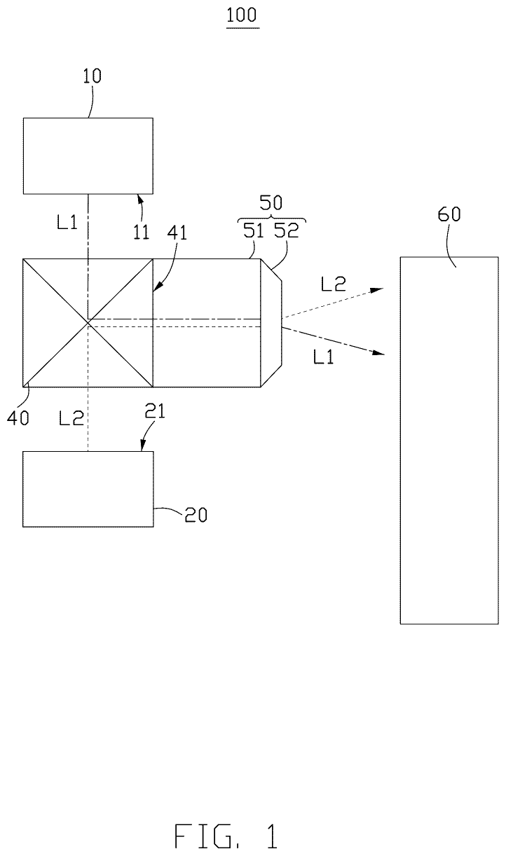

Referring to FIG. 1, a display apparatus 100 in this embodiment includes a first micro-display 10 including a first display surface 11, a second micro-display 20 including a second display surface 21, a light combining element 40 including a light exit surface 41, a projection lens 50, and an optical waveguide 60.

The first micro-display 10 is used to emit a first light beam L1 through the first display surface 11, the second micro-display 20 is used to emit a second light beam L2 through the second display surface 21, and the first light beam L1 and the second light beam L2 have different wavelengths. The first light beam L1 and the second light beam L2 are in different colors. The light combining element 40 is on optical paths of the first light beam L1 and the second light beam L2 and is used to receive the first light beam L1 and the second light beam L2. The light combining element 40 is further used to reflect the first light beam L1 and the second light beam L2 to the light exit surface 41. The first light beam L1 and the second light beam L2 exit out of the light combining element 40 through the light exit surface 41. The projection lens 50 is used to receive the first light beam L1 and the second light beam L2 from the light exit surface 41. The projection lens 50 is further used to project the first light beam L1 and the second light beam L2 after modulating optical parameters such as a focal length and a dispersion of the first light beam L1 and the second light beam L2. The optical waveguide 60 is used to receive the first light beam L1 and the second light beam L2 from the projection lens 50. The first light beam L1 and the second light beam L2 are coupled out of the optical waveguide 60 after multiple total reflections in the optical waveguide 60. The first light beam L1 and second light beam L2 coupled out of the optical waveguide 60 can be projected into an eye box to display images.

In this embodiment, the first light beam L1 is emitted in a first direction perpendicular to the first display surface 11, the second light beam L2 is emitted in a second direction perpendicular to the second display surface 21, the light exit surface 41 of the light combining element 40 directs the first light beam L1 and the second light beam L2 towards the projection lens 50 parallelly. The projection lens 50 includes a lens assembly 51 and a meta optical structure 52. The lens assembly 51 is used to modulate parameters of the first light beam L1 and the second light beam L2. The meta optical structure 52 is used to control directions of the first light beam L1 and the second light beam L2. In this embodiment, the first light beam L1 and the second light beam L2 incident on the lens assembly 51 parallelly, and the meta optical structure 52 is used to exit the first light beam L1 and the second light beam L2 at different angles, so that the first light beam L1 and the second light beam L2 with different wavelengths incident on a surface of the optical waveguide 60 at different angles (the first direction and the second direction are not parallel to each other).

The display apparatus 100 is used to display color images. The display apparatus 100 is used to emit the first light beam L1 and the second light beam L2 of different wavelengths (different colors), and the display apparatus 100 includes the optical waveguide 60 for guiding the first light beam L1 and the second light beam L2. The first light beam L1 and second light beam L2 of different wavelengths enter the optical waveguide 60 non-parallel (at different angles) because of the meta optical structure 52, thus a “rainbow effect” caused by a wavelength difference between the first light beam L1 and the second light beam L2 can be effectively improved.

### Embodiment 2

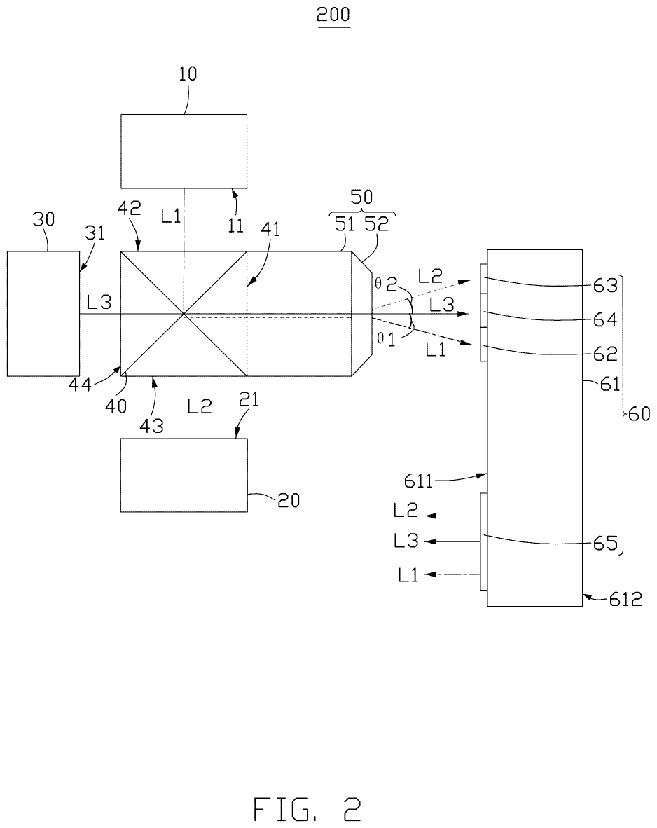

Referring to FIG. 2, a display apparatus 200 in this embodiment includes the first micro-display 10, the second micro-display 20, a third micro-display 30, the light combining element 40, the projection lens 50, and the optical waveguide 60. The first micro-display 10, the second micro-display 20, and the third micro-display 30 are respectively used to emit three kinds of light beams with different wavelengths. The light combining element 40 is used to combine and transmit the three kinds of light beams. The projection lens 50 is used to modulate the optical parameters such as the focal length and the dispersion of a combined light formed by the three kinds of light beams. The projection lens 50 is further used to adjust directions of the three kinds of light beams, respectively. The optical waveguide 60 is used to transmit the combined light from the projection lens 50 to the human eye for imaging.

The first micro-display 10 defines the first display surface 11 and is used to emit the first light beam L1 through the first display surface 11. The second micro-display 20 defines the second display surface 21 and is used to emit the second light beam L2 through the second display surface 21. The third micro-display 30 defines a third display surface 31 and is used to emit the third light beam L3 through the third display surface 31. In this embodiment, the first display surface 11 and the second display surface 21 are spaced apart and parallel to each other. The third display surface 31 is perpendicular to the first display surface 11 and the second display surface 22, respectively.

In this embodiment, the first micro-display 10 emits the first light beam L1 perpendicular to the first display surface 11, the second micro-display 20 emits the second light beam L2 perpendicular to the second display surface 21, and the third micro-display 30 emits the third light beam L3 perpendicular to the third display surface 31.

In this embodiment, the display apparatus 200 can be a head-mounted display, an augmented reality (AR) glasses, a virtual reality (VR) glasses, or a head-up display (HUD). The wavelength of the third light beam L3 is smaller than the wavelength of the first light beam L1 and is larger than the wavelength of the second light beam L2. The third light beam L3 incident to a surface of the optical waveguide 60 vertically, and the first light beam L1 and the second light beam L2 are on both sides of the third light beam L3. In this embodiment, the first light beam L1 is red light, the second light beam L2 is blue light, and the third light beam L3 is green light. The display apparatus 200 can achieve full color display according to a combined light of the first light beam L1, the second light beam L2 and the third light beam L3. In other embodiments of this disclosure, the first light beam L1, the second light beam L2, and the third light beam L3 may be other colors, and colors of the first light beam L1, the second light beam L2, and the third light beam L3 are different.

In this embodiment, the first micro-display 10, the second micro-display 20, and the third micro-display 30 can be light-emitting diode (LED) displays, organic light-emitting diodes (OLED) displays, mini light-emitting diode (Mini-LED) displays, micro light-emitting diode (Micro-LED) displays, liquid crystal on silicon (LCOS) displays, etc.

The light combining element 40 is in a space formed by the first micro-display 10, the second micro-display 20, and the third micro-display 30 and is on optical paths of the first light beam L1, the second light beam L2 and the third light beam L3. In the present embodiment, the light combining element 40 is a X-prism (or X-cube). The light combining element 40 further includes a first incident surface 42, a second incident surface 43 and a third incident surface 44. The first incident surface 42, the third incident surface 44, the second incident surface 43 and the light exit surface 41 are connected sequentially. The first display surface 11, the first incident surface 42, the second incident surface 43 and the second display surface 21 are parallel to each other. The first incident surface 42 faces the first display surface 11 to receive the first light beam L1, and the second incident surface 43 faces the second display surface 21 to receive the second light beam L2. The third display surface 31, the third incident surface 44 and the light exit surface 41 are parallel to each other. The third incident surface 44 faces the third display surface 31 to receive the third light beam L3.

The first light beam L1 from the first display surface 11 is vertically incident to the first incident surface 42 and transmitted to the light combining element 40, the second light beam L2 from the second display surface 21 is vertically incident to the second incident surface 43 and transmitted to the light combining element 40, and the third light beam L3 from the third display surface 31 is vertically incident to the third incident surface 44 and transmitted to the light combining element 40. The light combining element 40 is used to reflect the first light beam L1 and the second light beam L2 to the light exit surface 41 and to transmit the third light beam L3 to the light exit surface 41 so that the combined light of the first light beam L1, the second light beam L2 and the third light beam L3 are transmitted from the light exit surface 41 to the projection lens 50 parallelly.

The projection lens 50 is on the optical path of the first light beam L1, the second light beam L2 and the third light beam L3. In this embodiment, the projection lens 50 includes the lens assembly 51 and the meta optical structure 52. The meta optical structure 52 is fixed on a light-emitting end of the lens assembly 51. That is, the meta optical structure 52 is between the lens assembly 51 and the optical waveguide 60 and is attached to a side of the lens assembly 51 facing the optical waveguide 60.

The lens assembly 51 includes at least two lenses and is used to receive the first light beam L1, the second light beam L2, and the third light beam L3 from the light exit surface 41. The lens assembly 51 is further used to modulate optical parameters of the first light beam L1, the second light beam L2, and the third light beam L3 and transmit the first light beam L1, the second light beam L2, and the third light beam L3 parallelly. The lens assembly 51 can further include a polarizer, a filter, and other optical elements. The meta optical structure 52 is used to control directions of the first light beam L1, the second light beam L2, and the third light beam L3 from the lens assembly 51. The first light beam L1, the second light beam L2, and the third light beam L3 enter the projection lens 50 parallelly, and the meta optical structure 52 is further used to emit the first light beam L1, the second light beam L2, and the third light beam L3 at different angles (that is, different directions). In this embodiment, the third light beam L3 emits out of the meta optical structure 52 vertically, and the first light beam L1 and the second light beam L2 emit out of the meta optical structure 52 non-vertically. The first light beam L1 and the second light beam L2 are on both sides of the third light beam L3, respectively. The first beam and the second beam have non-zero angles with the third beam, respectively.

The optical waveguide 60 is on a side of the projection lens 50 away from the light combining element 40 and is used to receive the first light beam L1, the second light beam L2 and the third light beam L3 from the projection lens 50. The optical waveguide 60 is further used to couple out the first light beam L1, the second light beam L2 and the third light beam L3 for imaging. The first light beam L1, the second light beam L2 and the third light beam L3 enter the optical waveguide 60 at different angles (in directions not parallel to each other).

In this embodiment, the third light beam L3 is vertically incident to the optical waveguide 60, and the first light beam L1 and the second light beam L2 are non-vertically incident to the optical waveguide 60 and are on different sides of the third light beam L3. In this embodiment, the first light beam L1 and the second light beam L2 are symmetrically distributed on both sides of the third light beam L3. When the first light beam L1, the second light beam L2 and the third light beam L3 enter the optical waveguide 60, a first angle θ1 between the first light beam L1 and the third light beam L3 is equal to a second angle θ2 between the second light beam L2 and the third light beam L3. In other embodiments of this disclosure, when the first light beam L1, the second light beam L2 and the third light beam L3 enter the optical waveguide 60, the first angle θ1 may not be equal to the second angle θ2.

For example, in at least one embodiment of this disclosure, the first angle θ1 is less than or equal to 20° and the second angle θ2 is less than or equal to 20°. In at least one embodiment of this application, the first angle θ1 may be 5°, 10°, etc., and the second angle θ2 may also be 5°, 10°, etc. In this embodiment, the first angle θ1 and the second angle θ2 are related to wavelengths of the first light beam L1, the second light beam L2, and the third light beam L3, a refractive index of the optical waveguide 60, etc.

In the present embodiment, the optical waveguide 60 includes a single waveguide layer 61 and a first in-coupling grating 62, a second in-coupling grating 63, a third in-coupling grating 64, and an out-coupling grating 65 on a same surface of the waveguide layer 61. The first in-coupling grating 62 and the second in-coupling grating 63 are on both sides of the third in-coupling grating 64. The waveguide layer 61 includes a first surface 611 and a second surface 612 spaced apart and parallel to each other, and the first surface 611 is parallel to the light exit surface 41 of the light combining element 40. The first surface 611 is between the projection lens 50 and the second surface 612. The first in-coupling grating 62, the second in-coupling grating 63, the third in-coupling grating 64, and the out-coupling grating 65 are spaced apart on the first surface 611.

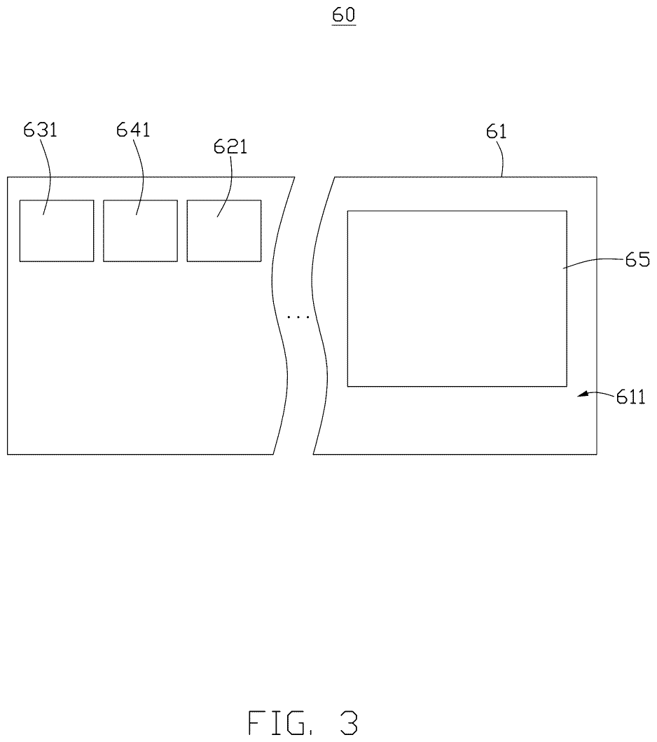

Referring to FIG. 3, in this embodiment, the first in-coupling grating 62, the second in-coupling grating 63, and the third in-coupling grating 64 are spaced apart on the first surface 611. An orthography projection of the first in-coupling grating 62 on the first surface 611 of the waveguide layer 61 is defined as a first in-coupling area 621, an orthography projection of the second in-coupling grating 63 on the first surface 611 of the waveguide layer 61 is defined as a second in-coupling area 631, and an orthographic projection of the third in-coupling grating 64 on the first surface 611 of the waveguide layer 61 is defined as a third in-coupling area 641. The first in-coupling area 621 and the second in-coupling area 631 are on both sides of the third in-coupling area 641. The first light beam L1 is not vertically incident to the first in-coupling area 621, the second light beam L2 is not vertically incident to the second in-coupling area 631, and the third light beam L3 is vertically incident to the third in-coupling area 641.

In this embodiment, the first in-coupling area 621, the second in-coupling area 631 and the third in-coupling area 641 are spaced apart from each other because the first angle θ1 and the second angle θ2 have large angle sizes, wherein the third in-coupling area 641 is between the first in-coupling area 621 and the second in-coupling area 631. The larger the angle size, the greater distances between the third in-coupling area 641 and the first in-coupling area 621 and the second in-coupling area 631.

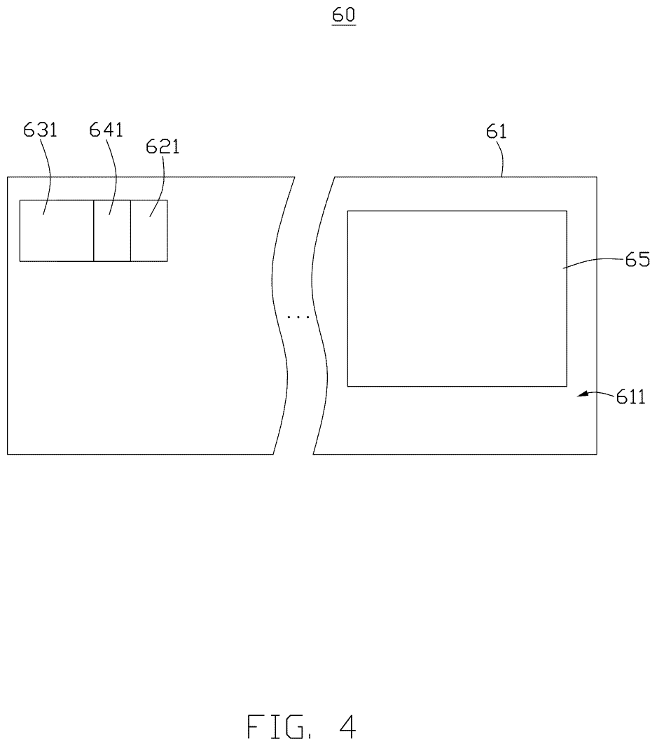

Referring to FIG. 4, in other embodiments, since the first angle θ1 and the second angle θ2 have small angle sizes, the third in-coupling area 641 may partially overlap with the first in-coupling area 621 and the second in-coupling area 631, respectively. As shown in FIG. 4, an area of the first in-coupling area 621 and an area of the second in-coupling area 631 is larger than an area of the third in-coupling area 641. The smaller the angle sizes, the larger overlapping areas of the third in-coupling area 641 and the first in-coupling area 621 and the second in-coupling area 631.

In the other embodiment, the first in-coupling grating 62, the second in-coupling grating 63, and the third in-coupling grating 64 are stacked sequentially, wherein the third in-coupling grating 64 is between the first in-coupling grating 62 and the second in-coupling grating 63. A sequence of the first in-coupling grating 62, the second in-coupling grating 63, and the third in-coupling grating 64 is not limited, and an overlapping relationship of the first in-coupling area 621, the second in-coupling area 631 and the third in-coupling area 641 is not limited, areas of the first in-coupling grating 62, the second in-coupling grating 63 and the third in-coupling grating 64 are not limited, an areas of the first in-coupling area 621, the second in-coupling area 631, and the third in-coupling area 641.

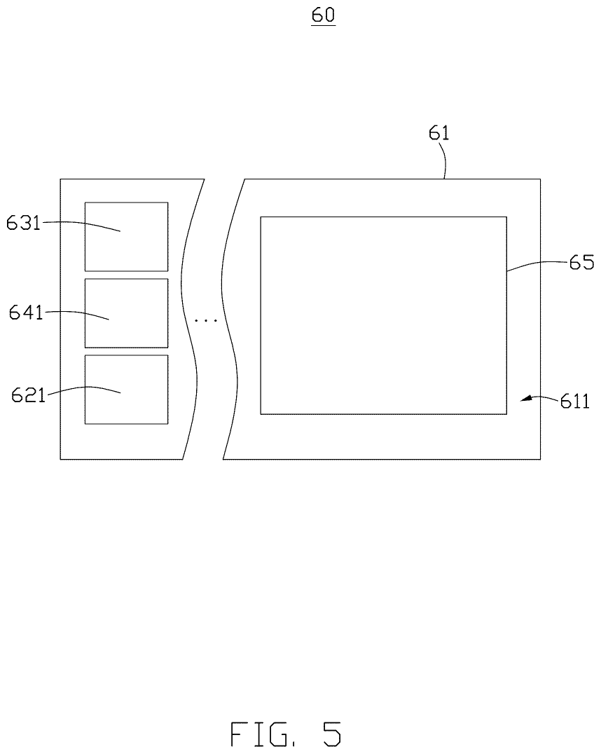

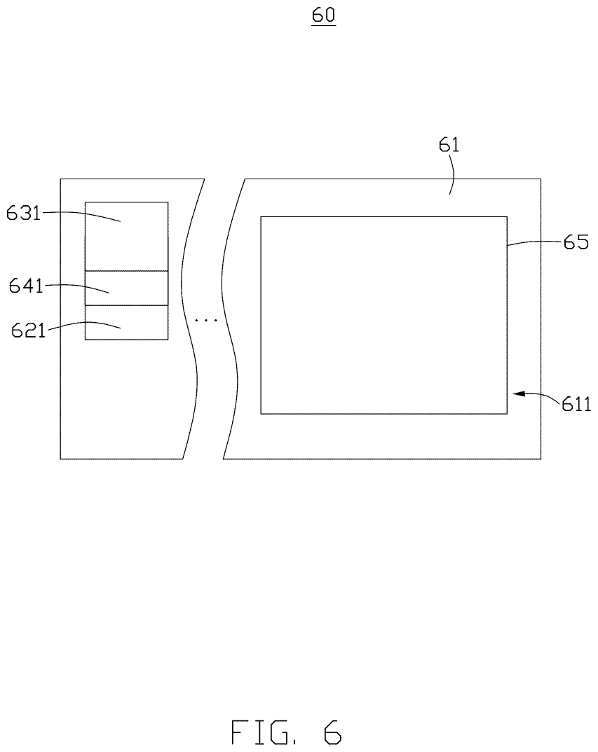

Referring to FIG. 5 and FIG. 6, in other embodiments of this disclosure, the first in-coupling grating 62, the second in-coupling grating 63 and the third in-coupling grating 64 on the waveguide layer 61 are arranged in different ways, resulting in different position relationships between the first in-coupling area 621, the second in-coupling area 631 and the third in-coupling area 641. In FIG. 5 and FIG. 6, the first in-coupling area 621, the second in-coupling area 631, and the third in-coupling area 641 are next to each other vertically instead of horizontally as shown in FIG. 3 and FIG. 4, and the first light beam L1 and second light beam L2 are distributed in on both sides (an upper side and a lower side) of the third light beam L3 in a different way from FIG. 3 and FIG. 4.

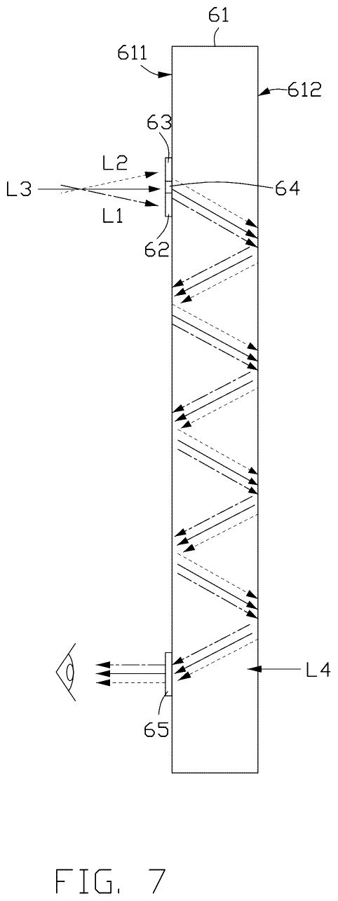

Referring to FIG. 7, in this embodiment, the three in-coupling gratings (62, 63, 64) locates at one end of the first surface 611, and the out-coupling grating 65 locates at the other end of the first surface 611. The first light beam L1, the second light beam L2, and the third light beam L3 coupled from the three in-coupling gratings coupled out from the out-coupling grating 65 after multiple total reflections in the waveguide layer 61, wherein first light beam L1, the second light beam L2, and the third light beam L3 are coupled to the user's eye box to display color images. When the display apparatus 200 is an AR glass, the waveguide layer 61 is also used to transmit ambient light L4. The ambient light L4 is transmitted from the second surface 612 to the first surface 611 and coupled out from the coupled grating 65 with the first light beam L1, the second light beam L2 and the third light beam L3, so that the human eye can simultaneously observe the images displayed by the display apparatus 200 and the real world (that is, the AR image).

In this embodiment, the display apparatus 200 includes the projection lens 50 including the meta optical structure 52. The first light beam L1, the second light beam L2, and the third light beam L3 emit out of the light combining element 40 parallelly, and the meta optical structure 52 is used to control the first light beam L1, the second light beam L2, and the third light beam L3 emit out of the projection lens 50 non-parallelly. Therefore, the first light beam L1, the second light beam L2, and the third light beam L3 are incident on the optical waveguide 60 in a non-parallel manner. Due to different wavelengths of the first light beam L1, the second light beam L2 and the third light beam L3, if the first light beam L1, the second light beam L2 and the third light beam L3 incident on the optical waveguide 60 parallel, total reflection angles of the first light beam L1, the second light beam L2 and the third light beam L3 in the optical waveguide 60 will be different, which leads to the first light beam L1, the second light beam L2 and the third light beam L3 coupling out from different positions of the optical waveguide 60 and uneven distribution of the light beams in the eye box, thereby the “rainbow effect” is caused.

Therefore, the display apparatus 200 of this embodiment can reduce differences of the total reflection angles of the first light beam L1, the second light beam L2 and the third light beam L3 in the optical waveguide 60 by making the first light beam L1, the second light beam L2 and the third light beam L3 incident on the optical waveguide 60 non-parallel. Thus, the first light beam L1, the second light beam L2, and the third light beam L3 propagate in the optical waveguide 60 tending parallel, thereby coupling the first light beam L1, the second light beam L2, and the third light beam L3 out of the optical waveguide 60 parallelly, ensuring uniform distribution of various light beam within the eye box, improving the “rainbow effect”, and enhancing a color effect of the images displayed by the display device 200.

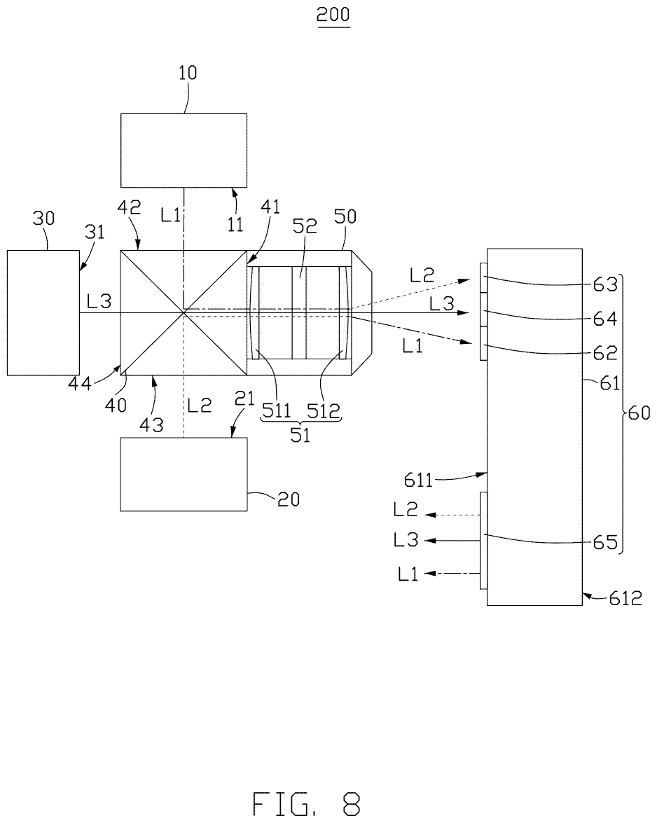

Referring to FIG. 8, in other embodiments, the meta optical structure 52 is integrated within the lens assembly 51. For example, the lens assembly 51 includes a first lens 511 and a second lens 512, the meta optical structure 52 is between the first lens 511 and the second lens 512. The lens assembly 51 may include other optical elements, and the meta optical structure 52 can locate between any two optical elements in the lens assembly 51.

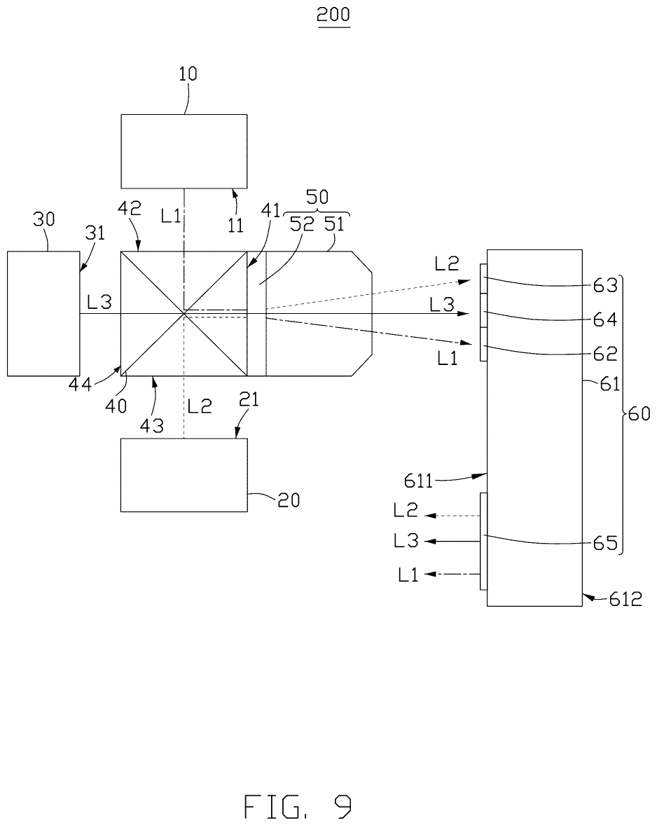

Referring to FIG. 9. in other embodiment, the meta optical structure 52 is at a light incident side of the lens assembly 51. That is, the meta optical structure 52 is between the light exit surface 41 and the lens assembly 51. The first light beam L1, the second light beam L2, and the third light beam L3 are emitted out of the light exit surface 41 parallelly and enter the meta optical structure 52 parallelly. After being regulated by the meta optical structure 52, the first light beam L1, the second light ray L2, and the third light ray L3 are emitted out of the meta optical structure 52 at different angles to the lens assembly 51.

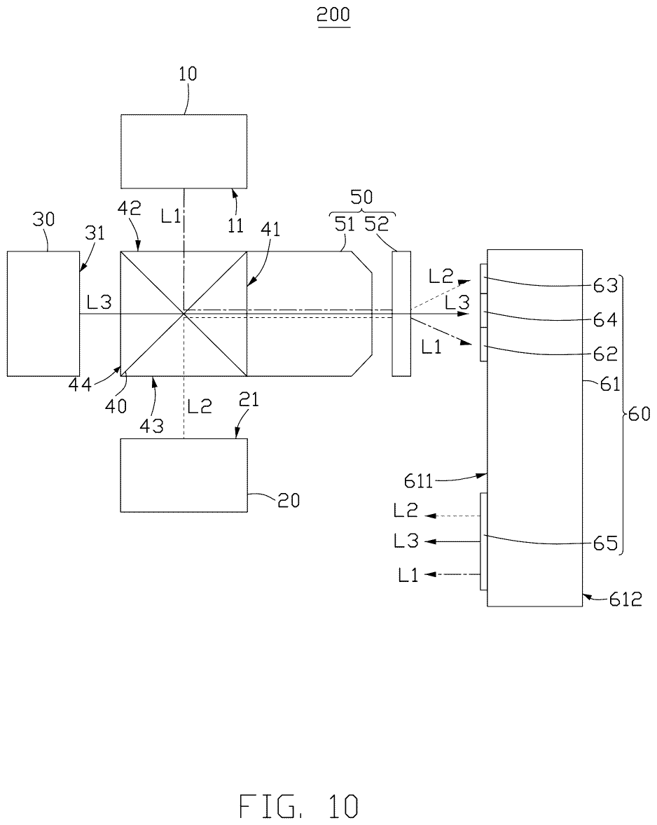

Referring to FIG. 10, in other embodiment, the meta optical structure 52 is between the lens assembly 51 and the optical waveguide 60 and is spaced apart from the lens assembly 51 and the optical waveguide 60. The first light beam L1, the second light beam L2, and the third light beam L3 are emitted out of the lens assembly 51 parallelly and enter the meta optical structure 52 parallelly. After being regulated by the meta optical structure 52, the first light beam L1, the second light beam L2, and the third light beam L3 emit out of the meta optical structure 52 at different angles.

As shown in FIGS. 8-10, the lens assembly 51 is used to modulate the optical parameters of the first light beam L1, the second light beam L2, and the third light beam L3. The meta optical structure 52 is used to regulate propagation directions of the first light beam L1, the second light beam L2, and the third light beam L3. Different positional relationship between the lens assembly 51 and the meta optical structure 52 does not affect their respective functions. The projection lens 50 is ultimately used to emit the first light beam L1, the second light beam L2, and the third light beam L3 at different angles, so that the first light beam L1, the second light beam L2, and the third light beam L3 incident on the optical waveguide 60 non-parallelly. The display apparatuses 200 shown in FIGS. 8-10 can achieve all the beneficial effects of the display apparatus 200 shown in FIG. 2.

### Embodiment 3

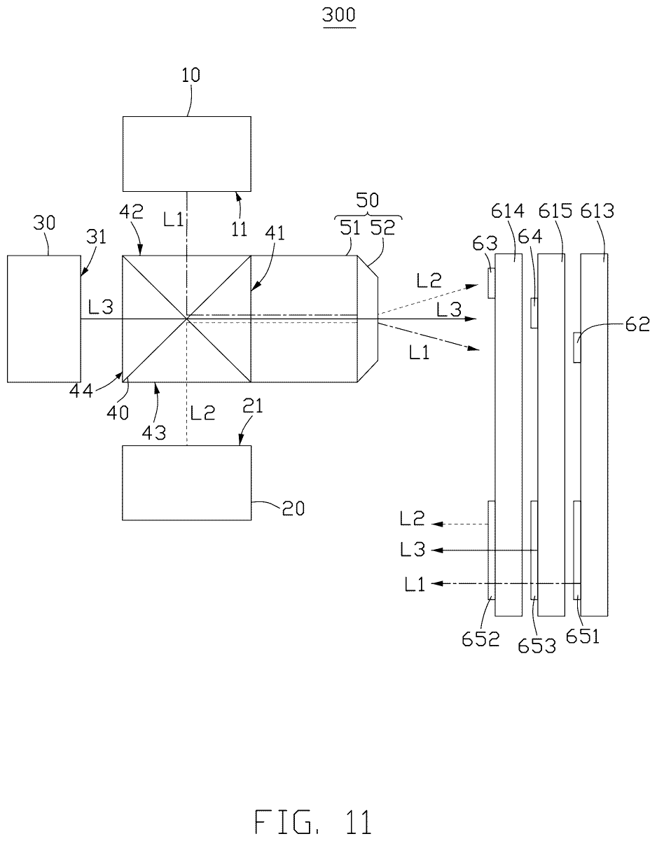

Referring to FIG. 11, a main difference between a display apparatus 300 in this embodiment and the display apparatus 200 in the second embodiment is that the structure of the optical waveguide 60.

In this embodiment, the optical waveguide 60 includes a first waveguide layer 613, a second waveguide layer 614, and a third waveguide layer 615, wherein the first waveguide layer 613, the third waveguide layer 615, and the second waveguide layer 614 are sequentially spaced apart and are parallel to each other. The first in-coupling grating 62 is on a surface of the first waveguide layer 613 towards the projected lens 50, the second in-coupling grating 63 is on a surface of the second waveguide layer 614 towards the projected lens 50, and the third in-coupling grating 64 is on a surface of the third waveguide layer 615 towards the projected lens 50.

The first light beam L1 is coupled into the first waveguide layer 613 through the first in-coupling grating 62 and is coupled out to the eye box after multiple total reflections in the first waveguide layer 613. The second light beam L2 is coupled into the second waveguide layer 614 through the second in-coupling grating 63 and is coupled out to the eye box after multiple total reflections in the second waveguide layer 614. The third light beam L3 is coupled into the third waveguide layer 615 through the third in-coupling grating 64 and is coupled out to the eye box after multiple total reflections in the third waveguide layer 615.

In this embodiment, the optical waveguide 60 also includes a first out-coupling grating 651, a second out-coupling 652, and a third out-coupling 653. The first out-coupling 651 is on the surface of the first waveguide layer 613 towards the third waveguide layer 615. The second out-coupling 652 is on the surface of the second waveguide layer 614 away from the third waveguide layer 615. The third out-coupling 653 is on the surface of the third waveguide layer 615 towards the second waveguide layer 614. Orthographic projections of the first out-coupling 651, the second out-coupling 652 and the third out-coupling 653 on the first waveguide layer 613 completely overlapping. The first out-coupling 651 is used to vertically couple the first light beam L1 out of the first waveguide layer 613, the second out-coupling 652 is used to vertically couple the second light beam L2 out of the second waveguide layer 614, the third out-coupling 653 is used to vertically couple the third light beam L3 out of the third waveguide layer 615. The first light beam L1, the second light beam L2, and the third light beam L3 are parallelly coupled out of the second coupling grating 652 to the eye box.

In this embodiment, orthographic projections of the first in-coupling grating 62, the second in-coupling grating 63, and the third in-coupling grating 64 on either waveguide layer (the first waveguide layer 613, the second waveguide layer 614, or the third waveguide layer 615) are completely overlapping. That is, the orthographic projections of the first in-coupling grating 62, the second in-coupling grating 63, and the third in-coupling grating 64 on any waveguide layer are partially overlapped or are completely separated (connected or spaced apart from each other).

The display apparatus 300 in this embodiment can achieve all the beneficial effects of the display apparatus 100 in the first embodiment. The structure of the first micro-display 10, the second micro-display 20, and the third micro-display 30 in FIG. 11 is taken as an example in FIG. 2. The structure of the first micro-display 10, the second micro-display 20, third micro-display 30, light combining element 40, and the projection lens 50 in this embodiment may be the same as described in any of the above-mentioned embodiments.

The display apparatuses (including display apparatus 100, 200, 300) in the above embodiments of this disclosure are used for displaying color images. The display apparatuses are used to transmit at least two kinds of light beams with different wavelengths, and the display apparatuses include an optical waveguide for transmitting the at least two kinds of light beams. The display apparatuses include the meta optical structure 52 to control the at least two kinds of light beams to incident on the optical waveguide in a non-parallel manner (that is, at different angles), which can compensate for total reflection angle difference caused by wavelength difference between the at least two kinds of light beams. Therefore, the total reflection angles of the at least two kinds of light beams tend to be the same when propagating in the optical waveguide. That is, the at least two kinds of light beams tend to propagate parallel in the optical waveguide, which causes color uniform when the at least two kinds of light beams coupled from the optical waveguide and can effectively improve the “rainbow effect”.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. A display apparatus comprising:
a first micro-display configured to emit a first light beam;
a second micro-display configured to emit a second light beam having a wavelength different from a wavelength of the first light beam;
a light combining element comprising a light exit surface on optical paths of the first light beam and the second light beam, and the light combining element configured to receive the first light beam and the second light beam and transmit the first light beam and the second light beam through the light exit surface;
a projection lens comprising a lens assembly and a meta optical structure, the lens assembly being configured to receive and modulate the first light beam and the second light beam exit from the light exit surface, the meta optical structure configured to control directions of the first light beam and the second light beam modulated by the lens assembly such that the first light beam and the second light beam exit from the projection lens are at different angles; and
an optical waveguide configured to receive the first light beam and the second light beam exit from the projection lens, wherein the projection lens is configured to project the first light beam and the second light beam to the optical waveguide in respective directions, the respective directions are not parallel to each other.

2. The display apparatus according to claim 1, wherein the meta optical structure is between the lens assembly and the optical waveguide.

3. The display apparatus according to claim 2, wherein the meta optical structure is fixed on the lens assembly.

4. The display apparatus according to claim 2, wherein the meta optical structure is spaced apart from the lens assembly and the optical waveguide.

5. The display apparatus according to claim 1, wherein the meta optical structure is between the lens assembly and the light combining element.

6. The display apparatus according to claim 1, wherein the lens assembly comprises at least two lenses, and the meta optical structure is between the at least two lenses.

7. The display apparatus according to claim 1, wherein the light combining element comprises a first incident surface and a second incident surface; and
the first incident surface receives the first light beam from the first micro display perpendicularly, the second incident surface receives the second light beam form the second micro-display perpendicularly, and the light combining element is further configure to transmit the first light beam and the second light beam through the light exit surface parallelly.

8. The display apparatus according to claim 7, wherein the light combining element is an X-prism, the first incident surface and the second incident surface are parallel to each other and perpendicular the light exit surface.

9. The display apparatus according to claim 1, wherein the meta optical structure is a metalens.

10. The display apparatus according to claim 1, wherein the optical waveguide comprises a first in-coupling grating, a second in-coupling grating, and at least one waveguide layer, the first in-coupling grating couples the first light beam into the at least one waveguide layer, and the second in-coupling grating couples the second light beam into the at least one waveguide layer; and
orthographic projections of the first in-coupling grating and the second in-coupling grating on the at least one waveguide layer are adjacent to each other.

11. The display apparatus according to claim 10, wherein the at least one waveguide layer comprises a single waveguide layer configured for transmitting the first light beam and the second light beam, and the first in-coupling grating and the second in coupling grating are on a same surface of the single waveguide layer.

12. The display apparatus according to claim 10, wherein the at least one waveguide layers comprises a first waveguide layer configured for transmitting the first light beam; and a second waveguide layer configured for transmitting the second light beam, the first waveguide layer is adjacent to the second waveguide layer, the first in-coupling grating is on the first waveguide layer, and the second in-coupling grating is on the second waveguide layer.

13. The display apparatus according to claim 1, further comprising a third micro-display configured for emitting a third light beam in a third direction, and the wavelength of the first light beam, the wavelength of the second light beam, and a wavelength of the third light beam are different from each other;
the light combining element is further configured to receive the third light beam and transmit the third light beam through the light exit surface; and
the projection lens is further configured to receive the third light beam, the lens assembly is further configured to modulate the third light beam, the meta optical structure is further configured to control a direction of the third light beam modulated by the lens assembly such that the first light beam, the second light beam, and the third light beam incident on the optical waveguide at different angles.

14. The display apparatus according to claim 13, wherein the optical waveguide further comprises a first in-coupling grating, a second in-coupling grating, a third in-coupling grating, and at least one waveguide layer, the first light beam is coupled into the at least one waveguide layer from the first in-coupling grating, the second light beam is coupled into the at least one waveguide layer from the second in-coupling grating, and the third light beam is coupled into the at least one waveguide layer from the third in-coupling grating; and
orthographic projections of the first in-coupling grating, the second in-coupling grating, and the third in-coupling grating on the waveguide layer are adjacent to each other.

15. The display apparatus according to claim 14, wherein the at least one waveguide layer comprises a single waveguide layer configured for transmitting the first light beam, the second light beam, and the third light beam, and the first in-coupling grating, the second in-coupling grating, and the third in-coupling grating are on a same surface of the single waveguide layer.

16. The display apparatus according to claim 14, wherein the at least one waveguide layers comprises a first waveguide layer configured for transmitting the first light beam, a second waveguide layer configured for transmitting the second light beam, and a third waveguide layer configured for transmitting the third light beam, the first waveguide layer, the second waveguide layer, and the third waveguide layer are sequentially stacked at intervals, the first in-coupling grating is on the first waveguide layer, the second in-coupling grating is on the second waveguide layer, and the third in-coupling grating is on the third waveguide layer.

17. The display apparatus according to claim 13, wherein a wavelength of the third light beam is smaller than a wavelength of the first light beam and is greater than a wavelength of the second light beam, and the third micro-display is further configured to emit the third light beam in a third direction that is perpendicular to the optical waveguide.

18. The display apparatus according to claim 13, wherein a first angle between the first direction and the third direction is equal to a second angle between the second direction and the third direction.

19. The display apparatus according to claim 1, wherein the optical waveguide is further configured to propagate the first light beam and the second light beam propagate parallelly.

20. A display apparatus comprising:
a first micro-display configured to emit a first light beam;
a second micro-display configured to emit a second light beam, and a color of the first light beam is different from a color of the second light beam;
a light combining element comprising a light exit surface on optical paths of the first light beam and the second light beam, and configured to receive the first light beam and the second light beam and transmit the first light beam and the second light beam through the light exit surface;
a projection lens comprising a lens assembly and a meta optical structure, the lens assembly being configured to receive and modulate the first light beam and the second light beam exit from the light exit surface, the meta optical structure configured to control directions of the first light beam and the second light beam modulated by the lens assembly such that the first light beam and the second light beam exit from the projection lens are at different angles; and
an optical waveguide configured to receive the first light beam and the second light beam from the projection lens, wherein the projection lens is configured to project the first light beam and the second light beam to the optical waveguide in respective directions, the respective direction are not parallel to each other.
